(19) United States
(12) Patent Application Publication
(10) Pub. No.: US 2018/0127528 A1
(43) Pub. Date: May 10, 2018

(54) SMOOTHNESS IMPROVING ADDITIVE FOR CALENDERING PROCESS

(71) Applicant: LG MMA CORP., Yeosu-si (KR)

(72) Inventors: Hyo Jung SEO, Daejeon (KR); Kyoung Ah CHANG, Daejeon (KR); Yo Han JUNG, Daejeon (KR); Eun Jin JEON, Daejeon (KR)

(73) Assignee: LG MMA CORP., Yeosu-si (KR)

(21) Appl. No.: 15/803,884

(22) Filed: Nov. 6, 2017

(30) Foreign Application Priority Data
Nov. 4, 2016 (KR) 10-2016-0146781

(51) Int. Cl. C08F 220/06; C08F 120/06; C08L 33/10; C08L 27/06; B29C 43/24

(52) U.S. Cl. CPC C08F 220/06; C08F 120/06; C08L 33/10; C08L 27/06; B29C 2043/5825; C08F 2500/01; C08F 2500/12; C08L 2201/50; C08L 2205/06; B29C 43/24

(57) ABSTRACT

Provided are a smoothness improving additive for a calendering process and a polyvinylchloride-based composition including the same. More particularly, a smoothness improving additive allowing, even in the case of using a plasticizer in a smaller amount than the conventional amount used, excellent productivity and excellent processability in a calendering process to accelerate a production speed, excellent mechanical physical properties such as glass transition temperature and tensile strength of a molded body, and manufacture of a molded body having better smoothness is provided.

### CROSS-REFERENCE TO RELATED APPLICATIONS

This application claims priority under 35 U.S.C. §119 to Korean Patent Application No. 10-2016-0146781, filed on Nov. 4, 2016, in the Korean Intellectual Property Office, the disclosure of which is incorporated herein by reference in its entirety.

### TECHNICAL FIELD

The following disclosure relates to a smoothness improving additive for a calendering process, and more particularly, to a smoothness improving additive allowing, even in the case of using a plasticizer in a smaller amount than the conventional amount used, excellent productivity and excellent processability in a calendering process to accelerate a production speed, excellent mechanical physical properties such as glass transition temperature and tensile strength of a molded body, and manufacture of a molded body having better smoothness.

### BACKGROUND

Flooring manufactured by a method such as extrusion or calendering using a petroleum-based resin such as polyvinylchloride (PVC) is widely used as a flooring material in buildings such as houses, mansions, apartments, offices or stores.

The calendering method has a faster production speed than the extrusion method, and thus, has excellent productivity. The calendering method is economical and very efficient means for manufacturing film and sheet from a polymer such as polyvinylchloride. The film or sheet manufactured by the calendering method may be easily thermoformable into various shapes, thereby being widely used, for example, in packaging, graphic arts, security cards, wallpaper, binding, folders, floor tiles, and products to be printed, decorated or laminated by a secondary process.

A polyvinylchloride composition for being used as flooring is manufactured into a sheet by an extrusion or calendering method, and when the flooring is manufactured by the calendering method, a plasticizer such as a phthalate-based plasticizer is commonly included for improving processability. However, in the case of using the plasticizer, the glass transition temperature of the polyvinylchloride composition is lowered to 20° C. or less, and accordingly, the sheet manufactured therefrom is flexible, and in the case that the sheet is constructed on an uneven floor, it sags such that it transfers the shape of a floor surface as it is, thereby decreasing smoothness after construction. In addition, the sheet becomes softer depending on a temperature condition when stored and moved, thereby becoming a factor to further decrease smoothness.

In the case that the plasticizer is removed or decreased, calendering processability is poor, a production yield is lowered, and the product is so hard that the texture thereof is not good when used.

### SUMMARY

An embodiment of the present invention is directed to providing a smoothness improving additive for a calendering process used together with a plasticizer wherein the plasticizer is used in a smaller amount than the conventional amount used. Further, an embodiment of the present invention is directed to providing a smoothness improving additive for a calendering process which, when used in combination with a plasticizer, allows excellent productivity and excellent processability in a calendering process to accelerate a production speed, even in the case that the plasticizer is used in a smaller amount than the conventional amount used.

Further, an embodiment of the present invention is directed to providing a polyvinylchloride-based composition including the smoothness improving additive provided by the present invention. Specifically, the polyvinylchloride-based composition has a glass transition temperature of 70° C. or more to have excellent thermal resistance, excellent smoothness, no deterioration of mechanical physical properties such as tensile strength as compared with those when using a plasticizer alone, and excellent processability.

Further, an embodiment of the present invention is directed to providing hard flooring without sagging or deformation even under a high temperature condition by using the polyvinylchloride-based composition.

As a result of researching for achieving the above objectives, the inventors of the present invention found that by improving the thermal resistance of a polyvinylchloride-based composition, a final molded body has excellent smoothness, and when a methylmethacrylate-based resin having a molecular weight within a specific range is used as an additive having no adverse effect on moldability or other mechanical physical properties, the objectives may be achieved, thereby completing the present invention.

In one general aspect, a smoothness improving additive for a calendering process includes:

a methylmethacrylate-based polymer having a weight average molecular weight of 16,000-48,000 g/mol and a melt index of 0.2-15 g/10 min, measured at 170° C. under 3.8 kg.

In another general aspect, a base layer for polyvinylchloride-based flooring includes the smoothness improving additive.

In another general aspect, a polyvinylchloride-based composition for a calendering process includes a polyvinylchloride-based resin, a plasticizer, and a methylmethacrylate-based polymer having a weight average molecular weight of 16,000-48,000 g/mol and a melt index of 0.2-15 g/10 min, measured at 170° C. under 3.8 kg as a smoothness improving additive.

In another general aspect, polyvinylchloride-based flooring includes a molded body in a film or sheet form using the polyvinylchloride-based composition for a calendering process.

Other features and aspects will be apparent from the following detailed description, and the claims.

### DETAILED DESCRIPTION OF EMBODIMENTS

The advantages, features and aspects of the present invention will become apparent from the following description of the embodiments. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, the present invention will be described in more detail with reference to the exemplary embodiments and Examples including the accompanying drawings. However, the following exemplary embodiments and Examples are only a reference for describing the present invention in detail, and the present invention is not limited thereto, and may be implemented in various forms.

In addition, unless otherwise defined, all technical terms and scientific terms have the same meanings as those commonly understood by a person skilled in the art to which the present invention pertains, the terms used herein are only for effectively describing a certain exemplary embodiment, and not intended to limit the present invention.

In addition, the singular form used in the specification and claims appended thereto may be intended to also include a plural form, unless otherwise indicated in the context.

One embodiment of the present invention provides a smoothness improving additive for a calendering process including:

a methylmethacrylate-based polymer having a weight average molecular weight of 16,000-48,000 g/mol and a melt index of 0.2 to 15 g/10 min, measured at 170° C. under 3.8 kg.

In an exemplary embodiment of the smoothness improving additive of the present invention, the methylmethacrylate-based polymer may be any one resin or a mixed resin of two or more selected from the group consisting of a methylmethacrylate homopolymer and a methylmethacrylate copolymer.

In an exemplary embodiment of the smoothness improving additive of the present invention, the methylmethacrylate-based polymer may have a glass transition temperature of 90° C. or more.

In an exemplary embodiment of the smoothness improving additive of the present invention, the smoothness improving additive may be used in a calendering process of polyvinylchloride-based flooring.

Another embodiment of the present invention provides a base layer for polyvinylchloride-based flooring including the smoothness improving additive.

In an exemplary embodiment of the base layer for polyvinylchloride-based flooring of the present invention, the base layer may have a thickness of 1.0 to 5.0 mm.

Another embodiment of the present invention provides a polyvinylchloride-based composition for a calendering process including a polyvinylchloride-based resin, a plasticizer, and a methylmethacrylate-based polymer having a weight average molecular weight of 16,000 to 48,000 g/mol and a melt index of 0.2 to 15 g/10 min, measured at 170° C. under 3.8 kg as a smoothness improving additive.

In an exemplary embodiment of the polyvinylchloride-based composition for a calendering process of the present invention, the methylmethacrylate-based polymer may be any one resin or a mixed resin of two or more selected from the group consisting of a methylmethacrylate homopolymer and a methylmethacrylate copolymer.

In an exemplary embodiment of the polyvinylchloride-based composition for a calendering process of the present invention, the methylmethacrylate-based polymer may have a glass transition temperature of 90° C. or more.

In an exemplary embodiment of the polyvinylchloride-based composition for a calendering process of the present invention, the polyvinylchloride-based composition may have a glass transition temperature of 70° C. or more.

In an exemplary embodiment of the polyvinylchloride-based composition for a calendering process of the present invention, the polyvinylchloride-based composition may include 1-20 parts by weight of the plasticizer and 15 to 50 parts by weight of the methylmethacrylate-based polymer, based on 100 parts by weight of the polyvinylchloride resin.

In an exemplary embodiment of the polyvinylchloride-based composition for a calendering process of the present invention, the polyvinylchloride-based composition may further include 1 to 100 parts by weight of inorganic particles, based on 100 parts by weight of the polyvinylchloride resin.

In an exemplary embodiment of the polyvinylchloride-based composition for a calendering process of the present invention, the polyvinylchloride resin may be a polyvinylchloride straight resin.

Another embodiment of the present invention provides polyvinylchloride-based flooring including a molded body in a film or sheet form as a base layer using the polyvinylchloride-based composition for a calendering process of the one embodiment.

Hereinafter, the smoothness improving additive of the present invention will be described in detail.

The present invention is characterized by including a methylmethacrylate-based polymer having a weight average molecular weight of 16,000 to 48,000 g/mol, more preferably 20,000 to 45,000 g/mol, and a melt index of 0.2 to 15 g/10 min, more specifically 0.3 to 13 g/10 min, measured at 170° C. under 3.8 kg as a smoothness improving additive. Particularly, within the range satisfying the weight average molecular weight and the melt index of the methylmethacrylate-based polymer as described above, compatibility with a polyvinylchloride resin is excellent, processability in a calendering process is excellent even in the case of adding a plasticizer in a smaller amount than the conventional amount used, thereby improving productivity, there is no sagging or deformation in the sheet under a high temperature condition as compared with the case using the conventional composition using a plasticizer alone, and a molded body having no deterioration of mechanical physical properties may be manufactured.

The weight average molecular weight is measured using gel permeation chromatography after dissolving a sample in tetrahydrofuran (THF) which is a mobile phase solvent, and polymethylmethacrylate is used in the measurement as a reference material.

The weight average molecular weight range of the methylmethacrylate-based polymer is much narrower than the general range thereof, and by having the range as described above, the fluidity and the mechanical physical properties of the resin are balanced to represent excellent workability in the calendering process, and at the same time, the sheet manufactured by mixing it with the polyvinylchloride resin has excellent thermal resistance and hardness, thereby best representing the effect of the present invention.

When the weight average molecular weight is more than 48,000 g/mol, kneadability with the PVC is decreased, thereby increasing a gelling time, or requiring an additional mixing process, and when the weight average molecular weight is further increased, the methylmethacrylate-based polymer may not melt at a PVC processing temperature, which is thus not preferred. In order to solve the problem, the added amount of the methylmethacrylate-based polymer should be decreased, or the content of the plasticizer should be further increased, which, however, may not achieve the objective of the present invention for improving the flooring smoothness. When the molecular weight is less than 16,000 g/mol, it becomes similar to that of a commonly used low molecular weight plasticizer, and thus, the thermal resistance and the mechanical strength for securing appropriate processability for a calendering method and preventing sagging under a high temperature condition which are the objectives to be achieved in the present invention may not be imparted.

The methylmethacrylate-based polymer of the present invention as described above may have a melt index in a range of 0.2 to 15 g/10 min, specifically 0.3 to 13 g/10 min, and more preferably 0.4 to 10 g/10 min, measured at 170° C. under 3.8 kg. Within the range, processability in a calendering process is excellent to improve productivity, even in the case of adding a plasticizer in a smaller amount than the conventional amount used. In addition, mechanical physical properties such as thermal resistance, tensile strength and hardness which has been deteriorated by the use of a large amount of a plasticizer may be improved, and a polyvinylchloride-based molded body capable of increasing smoothness without sagging or deformation in a sheet under a high temperature condition as compared with the case using the conventional composition using the plasticizer alone may be manufactured. Within the range of the melt index, processability for a calendering process may be secured, the content of a plasticizer may be decreased, and thermal resistance for securing smoothness at a high temperature may be sufficiently secured, which are thus preferred.

In addition, the methylmethacrylate-based polymer may have a glass transition temperature in a range of 90° C. or more, more specifically 90 to 120° C., more preferably 95-115° C., and when the methylmethacrylate-based resin in this range is applied, the thermal resistance of the polyvinylchloride-based composition is improved, thereby preventing sagging or other deformation of a sheet even under a high temperature condition.

In an exemplary embodiment of the present invention, the methylmethacrylate-based polymer which includes a methylmethacrylate repeating unit may be a methylmethacrylate homopolymer obtained by polymerizing a methylmethacrylate monomer alone. Or, it may be a copolymer obtained by copolymerizing a mixture using 50 wt % or more, more specifically 60-95 wt % of methylmethacrylate as a main component, and alkyl(meth)acrylate in which the alkyl group has 1 to 8 carbon atoms as a comonomer. The comonomer may be specifically, for example, methylacrylate, ethylacrylate, ethylmethacrylate, butylacrylate, butylmethacrylate, methacrylic acid and the like.

In an exemplary embodiment of the present invention, the methylmethacrylate-based polymer is not limited as long as it is obtained by a known polymerization method such as suspension polymerization, solution polymerization and bulk polymerization.

Another embodiment of the present invention provides a polyvinylchloride-based composition for a calendering process including the methylmethacrylate-based polymer as a smoothness improving additive.

An exemplary embodiment of the present invention of the polyvinylchloride-based composition for a calendering process of the present invention may include a polyvinylchloride resin, a plasticizer, and a methylmethacrylate-based polymer having a weight average molecular weight of 16,000 to 48,000 g/mol and a melt index of 0.2 to 15 g/10 min, measured at 170° C. under 3.8 kg as a smoothness improving additive.

Another exemplary embodiment of the present invention of the polyvinylchloride-based composition for a calendering process of the present invention may include a polyvinylchloride resin, a plasticizer, a methylmethacrylate-based polymer having a weight average molecular weight of 16,000 to 48,000 g/mol and a melt index of 0.2 to 15 g/10 min, measured at 170° C. under 3.8 kg as a smoothness improving additive, and inorganic particles.

In an exemplary embodiment of the present invention, the polyvinylchloride-based composition may include the methylmethacrylate-based polymer as a smoothness improving additive to have a glass transition temperature of 70° C. or more. Usually in the case that the plasticizer is included, the glass transition temperature is 20° C. or less, and the sheet manufactured by a calendering process is so soft that it does not have good smoothness when stored or constructed on an uneven floor. Therefore, as a result of researching specifically for obtaining a sheet having no sagging or deformation at a room temperature or higher, and having excellent smoothness, it was found that the smoothness is excellent at a glass transition temperature in a range of 70° C. or more. More preferably, when manufacturing a film or sheet at a temperature in a range of 80 to 90° C., excellent smoothness, and improved processability and productivity in the calendering process may be obtained.

In an exemplary embodiment of the present invention, the polyvinylchloride-based composition for satisfying the physical property of a glass transition temperature of 70° C. or more may include 15 to 50 parts by weight of the methylmethacrylate-based polymer having a weight average molecular weight of 16,000 to 48,000 g/mol and a melt index of 0.2 to 15 g/10 min, measured at 170° C. under 3.8 kg, based on 100 parts by weight of the polyvinylchloride resin. The content of the polymethylmethacrylate-based polymer is not limited to the above, but the composition having a glass transition temperature of 70° C. or more may be prepared within the range, and may secure the physical properties equal to or better than those conventionally using the plasticizer such as phthalate alone.

In an exemplary embodiment of the present invention, the polyvinylchloride resin may be any one of a vinyl chloride homopolymer, a copolymer resin containing 50 wt % or more of vinyl chloride and a chlorinated polyvinylchloride resin. As a vinyl-based monomer copolymerizable with the vinyl chloride monomer, an olefin compound such as ethylene and propylene; vinyl esters such as vinyl acetate and vinyl propionate; unsaturated nitriles such as acrylonitrile; vinyl alkyl ethers such as vinyl methyl ether and vinyl ethyl ether; unsaturated fatty acids such as acrylic acid, methacrylic acid, itaconic acid and maleic acid; and a monomer generally copolymerizable with a vinyl chloride monomer such as anhydride of these fatty acids may be used alone or in combination of two or more. In addition, it may be a polyvinylchloride straight resin, but not limited thereto. The straight resin may be prepared by suspension polymerization, unlike a paste resin, thereby being used in various fields such as hard and soft applications. Specifically, as a commercialized example, LS080S from LG chem Ltd., etc. may be used, but not limited thereto.

In an exemplary embodiment of the present invention, the polyvinylchloride-based composition may further include a plasticizer as required, for further improving flexibility and processability. The plasticizer is not limited as long as it is commonly used in the polyvinylchloride-based composition, and specifically for example, a phthalate-based plasticizer, an isophthalate-based plasticizer and the like may be used, and more specifically, dioctylphthalate (DOP), dipropylheptyl phthalate (DPHP), diisodecyl phthalate (DIDP) and the like may be used. The content thereof is not limited, but 1-20 parts by weight may be used. When the plasticizer is used in an amount more than 20 parts by weight, by adding an excessive amount of the plasticizer, smoothness may be deteriorated, and bleed out of the plasticizer may occur, which causes a sticky surface of a molded body, and attachment of pollutants, and the plasticizer is not completely absorbed in a resin, thereby deteriorating productivity and workability.

In an exemplary embodiment of the present invention, the polyvinylchloride-based composition may further include inorganic particles as required. The inorganic particles are added for improving moldability, and further improving mechanical physical properties, and specifically for example, calcium carbonate, barium sulfate, titanium dioxide, zinc oxide, barium oxide, tin oxide, antimony oxide, kaolin, talc, clay, alumina, mica, zeolite, silicate clay, etc. may be used, but not limited thereto. The content of the inorganic particles may be 1-100 parts by weight, based on 100 parts by weight of the polyvinylchloride resin, but not limited thereto.

In addition, depending on the physical properties to be improved, an additive such as a lubricant, an antioxidant, a UV stabilizer and a processing stabilizer may be further added, but not limited thereto, and any additive commonly used in the art may be used without limitation.

The lubricant is added for imparting a lubrication property between polymer chains, and specifically, may be a fatty acid-based compound such as a stearic acid; a fatty acid ester-based compound such as butyl ester or octyl stearate; a mixture of a fatty acid and alcohol such as palmityl alcohol or stearyl alcohol; a fatty acid amide compound such as stearic acid amide or oleic acid amide; metallic soap; a hydrocarbon-based compound such as paraffin or polyethylene wax; or a mixture thereof, and preferably may be a stearic acid for a film or sheet. The lubricant may be used at 0.1-5 parts by weight, based on 100 parts by weight of the polyvinylchloride resin, but not limited thereto.

The processing stabilizer may be any one or a mixture of two or more selected from the group consisting of a Ca'Zn-based compound; a Ba-Zn-based compound; a Na—Zn-based compound; a K-Zn-based compound; an organic tin-based compound such as a mercaptide-based compound, a maleic acid-based compound or a carboxylic acid-based compound; a metallic soap-based compound such as Mg-stearate, Ca-stearate, Pb-stearate, Cd-stearate or Ba-stearate; a phenolic compound; a phosphate ester-based compound; and a phosphite ester-based compound. The processing stabilizer may be used at 0.1-10 parts by weight, based on 100 parts by weight of the polyvinylchloride resin, but not limited thereto.

Further, an embodiment of the present invention provides a method of calendering a film or sheet including the polyvinylchloride-based composition for a calendering process, using a calendering processing method.

The polyvinylchloride-based composition for a calendering process according to an exemplary embodiment of the present invention may be manufactured into a film or sheet by a calendering process, and the method is not particularly limited.

Specifically, for example, the method may include:
a) uniformly mixing a polyvinylchloride-based composition including a polyvinylchloride resin and a methylmethacrylate-based polymer having a weight average molecular weight of 16,000 to 48,000 g/mol and a melt index of 0.2 to 15 g/10 min, measured at 170° C. under 3.8 kg as a smoothness improving additive;
b) kneading the mixture at a temperature of 150 to 200° C. to obtain a sheet; and
c) passing the sheet through a calendering roll for calendering.

According to an exemplary embodiment of the present invention, by including a methylmethacrylate-based polymer having a weight average molecular weight of 16,000 to 48,000 g/mol and a melt index of 0.2 to 15 g/10 min, measured at 170° C. under 3.8 kg as an additive for improving smoothness, the film or sheet may have the physical properties similar or equivalent to the calendering film or sheet using the conventional plasticizer, excellent processability, and no sagging or deformation under a high temperature condition, thereby achieving the physical property of excellent smoothness. In addition, flexibility is possible with only a small content.

The molded body in a film or sheet form, manufactured by the calendering process may have a thickness of 0.1 to 5 mm, but not limited thereto.

An embodiment of the present invention includes polyvinylchloride-based flooring including the molded body as a base layer.

Specifically, the polyvinylchloride-based flooring may be formed by laminating a balance layer, a base layer, a printed layer, a transparent film layer and a surface treatment layer in sequence.

The balance layer which has a surface to be adhered to a floor surface in construction protects an opposite surface to the floor surface, and serves to prevent moisture from the floor. The thickness of the base layer is not limited, and may be 0.1 to 1.0 mm, but not limited thereto.

The printed layer which is a layer to which a certain pattern is imparted by pressing the layer with a printing roll having a carved pattern using a gravure printing method, a screen printing method or the like imparts aesthetics to the flooring. The thickness of the printed layer is not limited, but may be 0.01 to 0.5 mm.

The transparent film layer is for protecting a printed layer laminated underneath simultaneously with securing wear resistance so that scratches and the like do not occur by everyday use, and the thickness thereof is not limited, but may be 0.1 to 1.5 mm.

The surface treatment layer is for inhibiting yellowness and improving weatherability, and improving fouling resistance of flooring, and may be manufactured by including a binder resin and a UV stabilizer or coating a UV curable composition on a transparent film layer and then curing the composition by UV irradiation.

The base layer which is a base layer for the flooring of the present invention is manufactured by a calendering method, and may have a thickness of 1.0 to 5.0 mm, and the other flooring layers may be manufactured by an extrusion method, a calendering method, a blowing molding and the like.

The manufacturing process of the flooring according to the present invention may include a raw material mixing process, a kneading process of heating and pressing the raw materials to uniformly mix them, a primary mixing process, a secondary mixing process, a calendering process of molding a final sheet shape, a laminating process and a winding process.

Hereinafter, the present invention will be described in more detail with reference to the Examples and Comparative Examples. However, the following Examples and Comparative Examples are only an example for describing the present invention in detail, and do not limit the present invention in any way.

Hereinafter, the physical properties of the polyvinylchloride-based composition and the flooring base layer manufactured using that composition were measured by the following measuring methods:

1. Glass transition temperature (T_{g}): measured at a heating rate condition of 10° C./min using a differential scanning calorimeter (DSC).

2. Weight average molecular weight: measured using gel permeation chromatography (GPC) by dissolving the prepared polymer in tetrahydrofuran.

The weight average molecular weight was measured using gel permeation chromatography (GPC) equipment from WATERS. The equipment includes a mobile phase pump (M515 Pump), a column heater (ALLCOLHTRB), a detector (2414 R.I. Detector) and an injector (2695 EB automatic injector), the analytical column was Styragel HR from WATERS, and the standard material was polymethylmethacrylate (PMMA) American polymer standard corporation STD. The mobile phase solvent was HPLC grade tetrahydrofuran (THF), and the measurement was carried out under the condition of a column heater temperature of 40° C., and a mobile phase solvent flow rate of 1.0 mL/min. A resin prepared for sample analysis was dissolved in tetrahydrofuran (THF) as the mobile phase solvent, and then injected into GPC equipment to measure a weight average molecular weight.

3. Smoothness

After two pedestals having a thickness of 100 mm were prepared, and spaced apart from each other at a 200 mm interval, a prepared polyvinylchloride-based sheet sample of width of 300 mm×length of 150 mm×thickness of 4.0 mm was put on the pedestals, and stood for 30 minutes, respectively, with heating from 30° C. to 80° C. at an increasing rate of 10° C., and then was evaluated for sheet sagging between the two pedestals.

The smoothness is represented according to the temperature at which sagging occurs, as follows:

⊚: no sagging even at 80° C.

o: no sagging at 70° C.

Δ: sagging at 50-60° C.

Δ: sagging at 40° C. or less

4. Processability

Calendering processability was evaluated, and is represented as follows:

o: not attached to a processing roll in the calendering processing, and continuously processable without disconnection

Δ: partially attached to a processing roll in the calendering process processing, or showing disconnection

x: incapable of calendering process

5. Melt Index

The weight of the resin sample obtained by extrusion from an orifice having a constant inner diameter at a temperature of 170° C. under a load of 3.8 kg for 10 minutes was measured.

### EXAMPLE 1

15 parts by weight of a methylmethacrylate-based polymer having a glass transition temperature of 98° C., a weight average molecular weight of 28,000 g/mol and a melt index of 3 g/10 min, measured at 170° C. under 3.8 kg, prepared by suspension polymerization, and 7 parts by weight of dioctylphthalate as a plasticizer, based on 100 parts by weight of a polyvinylchloride resin (LG Chem Ltd., LS080S) were added to a Banbury mixer, and kneaded at 170° C. for 5 minutes, thereby preparing a uniformly mixed composition. Next, the kneaded raw material was manufactured into a sheet using a calender roll at 160° C. Then, the sheet was preheated initially under 50 kgf/cm³ for 3 minutes in a press, and pressed under a raised pressure of 200 kgf/cm³ for 5 minutes, and then cooled to 40° C. or less, thereby manufacturing a sheet having a final thickness of 3.0 mm.

The physical properties of the thus-prepared sheet were evaluated, and are shown in the following Table 1.

### EXAMPLE 2

A sheet having a thickness of 3.0 mm was manufactured in the same manner as in Example 1, except for using 20 parts by weight of the methylmethacrylate-based polymer.

The physical properties of the thus-prepared sheet were evaluated, and are shown in the following Table 1.

### EXAMPLE 3

A sheet having a thickness of 3.0 mm was manufactured in the same manner as in Example 1, except for using 30 parts by weight of the methylmethacrylate-based polymer.

The physical properties of the thus-prepared sheet were evaluated, and are shown in the following Table 1.

### EXAMPLE 4

A sheet having a thickness of 3.0 mm was manufactured in the same manner as in Example 1, except for using 50 parts by weight of the methylmethacrylate-based polymer.

The physical properties of the thus-prepared sheet were evaluated, and are shown in the following Table 1.

### EXAMPLE 5

A sheet having a thickness of 3.0 mm was manufactured in the same manner as in Example 1, except for using 30 parts by weight of the methylmethacrylate-based polymer, and 14 parts by weight of the dioctylphthalate as the plasticizer.

The physical properties of the thus-prepared sheet were evaluated, and are shown in the following Table 1.

### EXAMPLE 6

A sheet having a thickness of 3.0 mm was manufactured in the same manner as in Example 1, except for using 40 parts by weight of the methylmethacrylate-based polymer, and 20 parts by weight of the dioctylphthalate as the plasticizer.

The physical properties of the thus-prepared sheet were evaluated, and are shown in the following Table 1.

### EXAMPLE 7

A sheet was manufactured in the same manner as in Example 1, except for using a methylmethacrylate-based polymer having a glass transition temperature of 100° C., a weight average molecular weight of 18,000 g/mol and a melt index of 14.5 g/10 min, measured at 170° C. under 3.8 kg, and then evaluated for the physical properties, which are shown in the following Table 1.

### EXAMPLE 8

A sheet was manufactured in the same manner as in Example 1, except for using a methylmethacrylate-based polymer having a glass transition temperature of 105° C., a weight average molecular weight of 45,000 g/mol and a melt index of 0.4 g/10 min, measured at 170° C. under 3.8 kg, and then evaluated for the physical properties, which are shown in the following Table 1.

### EXAMPLE 9

A sheet having a thickness of 3.0 mm was manufactured in the same manner as in Example 1, except for further adding 50 parts by weight of calcium carbonate having an average diameter of 3 μm.

The physical properties of the thus-prepared sheet were evaluated, and are shown in the following Table 1.

### COMPARATIVE EXAMPLE 1

A sheet was manufactured in the same manner as in Example 1, except for using a methylmethacrylate-based polymer having a glass transition temperature of 95° C., a weight average molecular weight of 15,000 g/mol and a melt index of 30 g/10 min, measured at 170° C. under 3.8 kg as the methylmethacrylate-based resin, and then evaluated for the physical properties, which are shown in the following Table 1.

### COMPARATIVE EXAMPLE 2

A sheet was manufactured in the same manner as in Example 1, except for using a methylmethacrylate-based polymer having a glass transition temperature of 99° C., a weight average molecular weight of 50,000 g/mol and a melt index of 0.1 g/10 min, measured at 170° C. under 3.8 kg as the methylmethacrylate-based resin, and then evaluated for the physical properties, which are shown in the following Table 1.

### COMPARATIVE EXAMPLE 3

A sheet was manufactured in the same manner as in Example 1, except for using a methylmethacrylate-based polymer having a glass transition temperature of 80° C., a weight average molecular weight of 8,000 g/mol and a melt index unmeasurable at 170° C. under 3.8 kg as the methylmethacrylate-based resin, and then evaluated for the physical properties, which are shown in the following Table 1.

### COMPARATIVE EXAMPLE 4

A sheet was manufactured in the same manner as in Example 1, except for using a polymethylmethacrylate-based polymer having a glass transition temperature of 93° C., a weight average molecular weight of 90,000 g/mol and a melt index unmeasurable at 170° C. under 3.8 kg as an acryl-based resin, and then evaluated for the physical properties, which are shown in the following Table 1.

### COMPARATIVE EXAMPLE 5

A sheet having a thickness of 3.0 mm was manufactured in the same manner as in Example 1, except for using 15 parts by weight of dioctylphthalate as the plasticizer and 50 parts by weight of calcium carbonate, based on 100 parts by weight of the polyvinylchloride resin (LG Chem Ltd., LS080S).

The physical properties of the thus-prepared sheet were evaluated, and are shown in the following Table 1.

### COMPARATIVE EXAMPLE 6

A sheet having a thickness of 3.0 mm was manufactured in the same manner as in Example 1, except for using 40 parts by weight of dioctylphthalate as the plasticizer and 50 parts by weight of calcium carbonate, based on 100 parts by weight of a polyvinylchloride resin (LG Chem Ltd., LS080S).

The physical properties of the thus-prepared sheet were evaluated, and are shown in the following Table 1.

TABLE 1

| | Glass | | |
|---|---|---|---|
| | transition | | |
| | temperature | | |
| | (° C.) | Smoothness | Processability |
| Example 1 | 74 | ◯ | ◯ |
| Example 2 | 76 | ◯ | ◯ |
| Example 3 | 79 | ⊚ | ◯ |
| Example 4 | 82 | ⊚ | ◯ |
| Example 5 | 76 | ◯ | ◯ |
| Example 6 | 75 | ◯ | ◯ |
| Example 7 | 72 | ◯ | ◯ |
| Example 8 | 81 | ⊚ | ◯ |
| Example 9 | 77 | ⊚ | ◯ |
| Comparative | 60 | Δ | ◯ |
| Example 1 | | | |
| Comparative | 78 | ◯ | Δ |
| Example 2 | | | |
| Comparative | 52 | Δ | Δ |
| Example 3 | | | |
| Comparative | 67 | unmeasurable | X |
| Example 4 | | | |
| Comparative | 45 | unmeasurable | X |
| Example 5 | | | |
| Comparative | 21 | X | ◯ |
| Example 6 | | | |

The smoothness improving additive for a calendering process and the polyvinylchloride-based composition including the same according to the present invention allow excellent processability even in the case of including a smaller amount of a plasticizer than the conventional amount.

In addition, a molded body may be manufactured by a calendering process, and its thermal resistance is excellent, and thus, there is no sagging or deformation in the manufactured molded body under a high temperature condition, thereby having excellent smoothness and excellent mechanical physical properties. In addition, the content of low molecular weight plasticizer is significantly lower than the conventional content, so that bleed out is reduced even at a high temperature or when use is prolonged.

1. A smoothness improving additive for a calendering process, comprising:
a methylmethacrylate-based polymer having a weight average molecular weight of 16,000 to 48,000 g/mol and a melt index of 0.2 to 15 g/10 min, measured at 170° C. under 3.8 kg.

2. The smoothness improving additive of claim 1, wherein the methylmethacrylate-based polymer is any one resin or a mixed resin of two or more selected from the group consisting of a methylmethacrylate homopolymer and a methylmethacrylate copolymer.

3. The smoothness improving additive of claim 1, wherein the methylmethacrylate-based polymer has a glass transition temperature of 90° C. or more.

4. The smoothness improving additive of claim 1, wherein the smoothness improving additive is used in a calendering process of polyvinylchloride-based flooring.

5. A base layer for polyvinylchloride-based flooring, comprising the smoothness improving additive of claim 1.

6. The base layer of claim 5, wherein the base layer has a thickness of 1.0 to 5.0 mm.

7. The smoothness improving additive of claim 2, wherein the smoothness improving additive is used in a calendering process of polyvinylchloride-based flooring.

8. A base layer for polyvinylchloride-based flooring, comprising the smoothness improving additive of claim 2.

9. The smoothness improving additive of claim 3, wherein the smoothness improving additive is used in a calendering process of polyvinylchloride-based flooring.

10. A base layer for polyvinylchloride-based flooring, comprising the smoothness improving additive of claim 3.

11. The base layer of claim 8, wherein the base layer has a thickness of 1.0 to 5.0 mm.

12. The base layer of claim 11, wherein the base layer has a thickness of 1.0 to 5.0 mm.
